(19) United States
(12) Patent Application Publication
(10) Pub. No.: US 2007/0279011 A1
(43) Pub. Date: Dec. 6, 2007

(54) Power Supply Systems For Electrical Devices

(75) Inventors: Stuart Michael Ruan Jones, Melbourn (GB); David Murray Cross, Letchworth (GB)

Correspondence Address: CARTER, DELUCA, FARRELL & SCHMIDT, LLP, 445 BROAD HOLLOW ROAD, SUITE 225, MELVILLE, NY, 11747, US

(73) Assignee: PA Consulting Services Limited, London (GB)

(21) Appl. No.: 10/589,105

(22) PCT Filed: Feb. 11, 2005
(86) PCT No.: PCT/GB05/00486

§ 371 Date: Jun. 21, 2007

(30) Foreign Application Priority Data
Feb. 11, 2004 (GB) 0403020.1

(51) Int. Cl. H02J 7/00

(52) U.S. Cl. 320/167; 320/166

(57) ABSTRACT

An electrically powered portable device, the device being other than a toothbrush, the device including means for providing a function to be performed by the device, an electrical power supply which incorporates at least one capacitor for storing electrical charge to power the device, electronic control circuitry to control electrical power drawn from the electrical power supply for driving the function providing means, and a recharge interface for recharging the electrical power supply, the recharge interface being arranged to be electrically connectable to a charging device.

The present invention relates generally to power supply systems for portable electrical devices. The present invention also relates to a portable charging device, and in particular to such a device used for delivering a fast electrical charge to a range of household electrical devices designed to incorporate a charge transfer interface and power storage device(s). The present invention also relates to a portable electrical device, in particular such a device adapted to be powered by such a portable charging device.

Many household electrical products require low power to deliver their specific function e.g. household delivery devices. Household delivery devices are used for the release of a range of volatile actives, including their use in delivery of air fresheners and pest control products. Such devices manifest themselves in a variety of forms that can generally be divided into passive and active systems. The latter incorporate an energy source to boost the release of actives and enable the effective use of lower volatile molecules. Other household electrical products require higher power delivery but for short times e.g. portable vacuum cleaners, electric carving knives, electric razors, toothbrushes, torches etc. Such devices are generally mains or battery driven.

Electrical mains powered or plug-in electrical systems meet the needs where a continuous power source is required with relatively high power usage. However such devices have a number of consumer negatives, such as: they occupy a mains outlet socket; they restrict the location opportunities for placing the product; they reduce the opportunity for maximum effectiveness, i.e. hidden behind furniture, away from the bed etc; they may not be suitable for UK bathrooms where safe power sockets (shaver outlets) are not so common; and/or they require electrical leads which trail, get in the way and can become hazardous with wear and tear.

Plug-in household delivery devices suffer from the additional problem that being hidden, they are difficult to get to, adjust and can lay empty for some time before this is noticed.

As an alternative and to provide increased portability, a large number of battery operated devices have been developed. These utilise a range of battery technologies and are either disposable or rechargeable.

A number of battery operated household delivery devices have launched (for example, SC Jobnson's “Glade Wisp” and Air Wick's Mobil’ Air air fresheners).

The use of batteries however, is often seen as a negative by the consumer since it necessitates another consumable element, which has a negative environmental impact, adds on-going cost and can easily be forgotten to replace or recharge, rendering the device inactive. Additionally batteries have a number of inherent characteristics i.e. high weight; adds bulk to the product, low power density.

Re-chargeable batteries address some of the above issues, although many of the inherent negatives still exist, such as: high weight; low power density (although NiCd cells address the power density issue to some extent); environmentally unfriendly; relatively slow re-charge rate even for “rapid charge” systems; and/or re-charge memory, limiting charge capacity if recharge regime is not followed and leading to reduced life expectancy of products where the rechargeable cells are not user replaceable.

In addition for air freshening and pest control devices, battery systems that utilise rechargeable technologies have historically been rejected since the time to recharge the battery cells can be significant. Air freshening and pest control is normally seen as an instantly reactive activity rather than one that you have several hours to plan, therefore for within this product category, the power source must to be able to be instantly respond to a need, for example for air freshener or pest control, rather being able to be inoperative during a recharge cycle.

Many portable household and healthcare electrical devices are battery operated and require higher power for short times e.g. household electrical devices, such as: small vacuum cleaners, DIY power tools especially including paint and adhesive applicators and removers, carving knives, personal grooming products including electric razors, hair clippers and manicure products, torches; and healthcare electrical devices, such as: medical device injectors, actuated blood glucose meters, inhalers, and wireless communications from drug compliance aids and monitors, etc.

Known hand held electric razors are either mains or battery powered, a number of the more expensive razors are powered by rechargeable batteries and typically claim a three minute quick charge feature. However, the need for batteries adds bulk, both size and weight, to the hand held razor. A three minute quick charge is still relatively slow compared with the preferred embodiment described here. Some known electric razors have accessories that can be conveniently stored on a base unit.

Other portable household and healthcare electrical devices require low power to deliver their specific function e.g. household delivery devices, non-actuated blood glucose meters, etc. Devices that deliver higher power for short times are more demanding of their energy sources. Batteries for such portable devices are generally rated to supply the peak power, to achieve minimum voltage drop, and prolong battery life.

Some electrically powered devices are operated progressively to consume consumables that are provided with the device. The consumables need to be replaced individually after each use, or more conveniently a number of consumables are provided in a single package. The single package can be loaded into the device to provide a number of future use cycles in a single recharge operation, or alternatively individual consumables may be unpackaged and individually loaded into the device. When the electrically powered device is battery operated, the user needs to remember to replace the battery, when discharged below a critical level, as well as the consumables. The life cycle of the battery and the consumables is generally different, so the user needs to remember to replace them at different times. Sometimes the device may not be working properly, because the battery may be partially discharged, or alternatively the user may dispose of the battery when replacing the consumables before the useful battery life has been reached, which is wasteful.

The invention aims to provide a charging device capable of delivering a fast charge to a range of electrical devices, in particular household and healthcare electrical devices.

The invention also aims to provide household and healthcare electrical devices having a power source capable of being fast charged.

The invention farther aims to provide electrical devices, in particular household and healthcare electrical devices, which have a power source that can provide improved performance as compared to known devices.

The invention also aims to provide a more effective supply of a battery and consumables for an electrically powered device.

According to a first aspect of the present invention there is provided an electrically powered portable device, the device being other than a toothbrush, the device including means for providing a function to be performed by the device, an electrical power supply which incorporates at least one capacitor for storing electrical charge to power the device, electronic control circuitry to control electrical power drawn from the electrical power supply for driving the function providing means, and a recharge interface for recharging the electrical power supply, the recharge interface being arranged to be electrically connectable to a charging device.

The electrically powered portable device may comprise a household delivery device such as an air freshener or pest control device, a vacuum cleaner, a kitchen appliance, such as an electric carving knife, a personal grooming product such as an electric razor, a hair clipper or a manicure product, a torch, a power tool, such as a paint and/or adhesive applicator or remover, or a healthcare electrical device, such as a medical device injector, an actuated blood glucose meter, an inhaler, and a wireless communications device from a drug compliance aid and/or monitor, etc.

Such devices are not limited to those identified above, which are used purely as illustration, but could also take the form of a variety of hand held portable powered cleaning products, kitchen utensils, personal grooming products etc characterised by either: medium power portable devices used for a relatively short time i.e. for illustration electric razors, torches, whisks, hair clippers, two-way pagers, GSM-protocol cell phones, hand-held GPS-systems, power tools and small vacuum cleaners. etc., or lower powered portable devices that may be continuous, pulsed or used intermittently and for which having to wait an extended period of time for recharging provides significant inconvenience, i.e. household delivery device etc.

In the first aspect of the present invention, the at least one capacitor preferably comprises at least one super-capacitor. The term “super-capacitor” is known to persons skilled in the art. In this specification, the term “super-capacitor” means a capacitor that has a capacitance of at least 5 Farads, most typically from 5 to 50 Farads, and preferably stores electrical charge electrostatically.

Preferably, the or each capacitor has a capacitance of from 5 to 50 Farad, more preferably from 10 to 50 Farad. Preferably, the at least one capacitor has a working output voltage of from 1V to 3.6V.

In a preferred embodiment there is provided a portable device, in particular a delivery device for the release of volatile actives such as air fresheners and pest control products, which utilises as a power source at least one fast charge super-capacitor. Super-capacitors inherently have a number of attributes that make them suitable for providing power for such portable devices, such as: very rapid charge (<15 seconds, ideally 2-15 seconds and more ideally 2-5 seconds); can be cycled thousands of times without detrimental effects or reduced life (no chemical reactions); light weight; high power density; extremely low internal impedance for high power, low loss charging and discharging; compact energy source (e.g. for a delivery device typically half the size of an AA battery for 2 to 4 hours use); the shape and dimensions can be readily customised for relatively low sales volumes; and environmentally friendly, allowing for improved alignment of the device manufacturers with proposed European recycling and transportation legislations specifically related to batteries and battery powered products.

Capacitors store energy in the form of separated electrical charge. The greater the area for storing charge, and the closer the separated charges, the greater the capacitance. A super-capacitor gets its area from a porous carbon-based electrode material which has much greater area than a conventional capacitor that has flat or textured films and plates.

A super-capacitor's charge separation distance is determined by the size of the ions in the electrolyte which is much smaller than conventional dielectric materials.

The combination of enormous surface area and extremely small charge separation gives the super-capacitor its outstanding capacitance relative to conventional capacitors.

A super-capacitor stores energy electrostatically by polarising an electrolytic solution. There are no chemical reactions involved in its energy storage mechanism. The mechanism is therefore efficient and highly reversible. A battery will store much more energy than the same size super-capacitor but in applications where power determines the size of the energy storage device, a super-capacitor may be a better solution. The super-capacitor is able to deliver frequent pulses of energy without any detrimental effects (small capacitors can deliver over 10 amps). Many batteries experience reduced life if exposed to frequent high power pulses. The super-capacitor can be charged extremely quickly. Many batteries are damaged by super-fast charging. The super-capacitor can be cycled hundreds of thousands of times. Batteries are generally capable of only a few hundred to a few thousand cycles depending on the chemistry.

Many applications can benefit from the use of super-capacitors, from those requiring short power pulses, to those requiring low power support of critical memory systems

The super-capacitors can be used alone, or in combination with other energy sources.

Super-capacitors have unique user benefits and provide greater flexibility in new product designs. Benefits include: very high efficiency; long cycle and application life; fast charge/discharge; high power capability (high current for up to 10 seconds); life extension for other energy sources e.g. battery; durable and flexible design (fit for rugged environments); wide temperature range (−35 to +65° C.); low maintenance; straightforward integration; cost effective, and available in high volume.

By providing the capacitance and low equivalent resistance of a capacitor in parallel with a battery, which has much higher internal impedance than a capacitor, the super-capacitor can be designed to support the battery and deliver the required peak power for short times. Super-capacitors are particularly good at providing peak power. A capacitor in parallel with a battery can significantly reduce voltage drop under peak power and extend battery life.

The size of the super-capacitor will be dependant on the device needs and will ideally drive the device for the period of the expected need of the device.

The present invention has particular application for use in medical devices, in particular medical devices that are required to deliver a high electrical power for a short duration, for example to drive a motor, a solenoid or an actuator. Typically, such devices are required to supply such high electrical power intermittently for short periods of time, and may comprise, for example, blood glucose meters, injectors or spikes, inhalers, pumps, compliance aids and monitors (which may provide an output via a wireless communication), low power surgical devices, such as for us in ophthalmic, orthopaedic, derma abrasion, chiropody and dentistry applications, and wound dressings, for example providing an additional monitoring or smart delivery function The medical devices may be designed to provide a single operation cycle from a single charge or multiple operation cycles as may be desired by the function of the device. The medical devices may also incorporate a coded trigger linked to the charging action, or burst wireless communications.

Most preferably, the medical device comprises a power supply comprising the combination of a voltage source, such as at least one battery, which may be disposable or rechargeable, and the at least one capacitor, with the voltage source and the at least one capacitor being arranged so that the voltage source substantially continually progressively charges the at least one capacitor for any period that the at least one capacitor is not fully charged. This provides that the capacitor can be used, rather than the voltage source, intermittently to provide the required high power for a short duration, but is substantially continually recharged by the voltage source.

According to a second aspect of the present invention there is provided an electrically powered portable charging device suitable for temporarily storing electrical charge for delivery to an electrical device electrically connectable to the charging device, the charging device comprising at least one storage element for temporarily storing electrical charge, an input for receiving, from a separate charging base unit to which the charging device is electrically connectable, an electrical charge to be stored by at least one storage element, and an output for delivering the stored electrical charge to the electrical device, the output comprising an electrical connector for selective electrical connection to an electrical device to be charged by the charging device.

A preferred embodiment provides a portable charging wand which can electrically mate with one or more portable powered household or medical devices having the electronics and circuitry developed so as to provide for very rapid re-charge rate in a consumer friendly way. Such powered devices are ideally suited to the use of fast charge super capacitors as the internal power source.

The wand can incorporate: re-chargeable batteries, trickle charged through a docking station plus suitable control circuitry which can in turn provide the super capacitors within the device or devices with high current flow and therefore provide for rapid charging through a simple electrical mating operation, and/or master super capacitors with high power rating charged from docking station plus suitable control circuitry which can in turn provide the super capacitors within the device or devices with high current flow and therefore provide for rapid charging through a simple electrical mating operation.

The charging wand may comprise of batteries, or high capacitance capacitors (generally known as super-capacitors), or a combination of battery, super-capacitor, and protection and voltage regulator control electronics.

Embodiments of the present invention will now be described, by way of example only, with reference to the accompanying drawings, in which:—

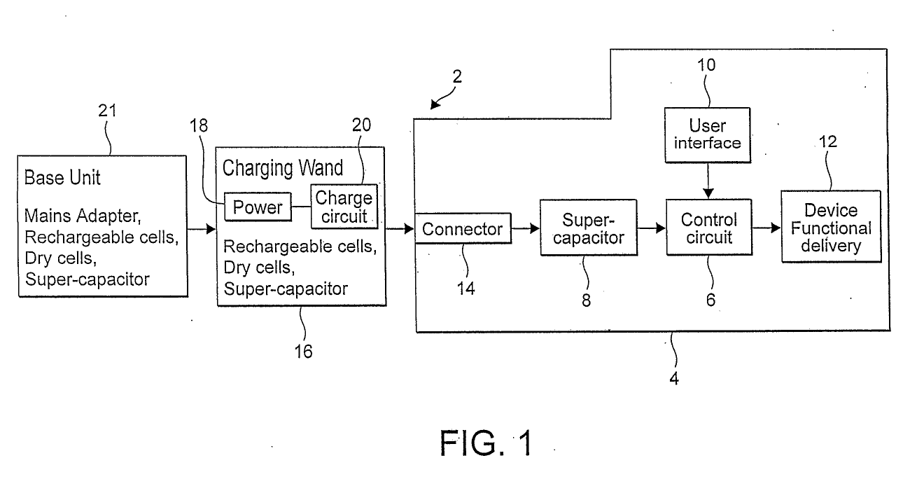

FIG. 1 is a schematic block diagram of a charging system for a portable electronic device in accordance with a first embodiment of the present invention, the system including a portable charging wand and a portable device chargeable by the portable charging wand;

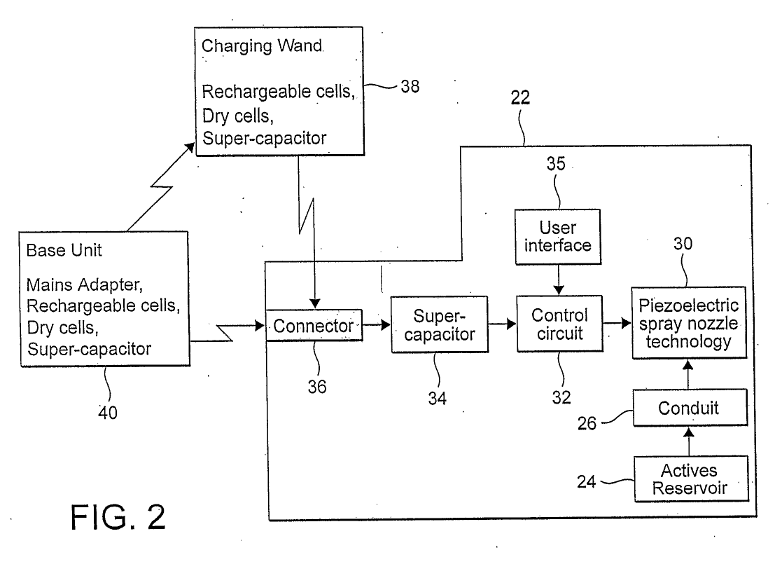

FIG. 2 is a schematic block diagram of a charging system for a portable electronic device in the form of a delivery device in accordance with a second embodiment of the present invention, the system including a portable charging wand and a delivery device, the delivery device being chargeable by the portable charging wand or a base unit;

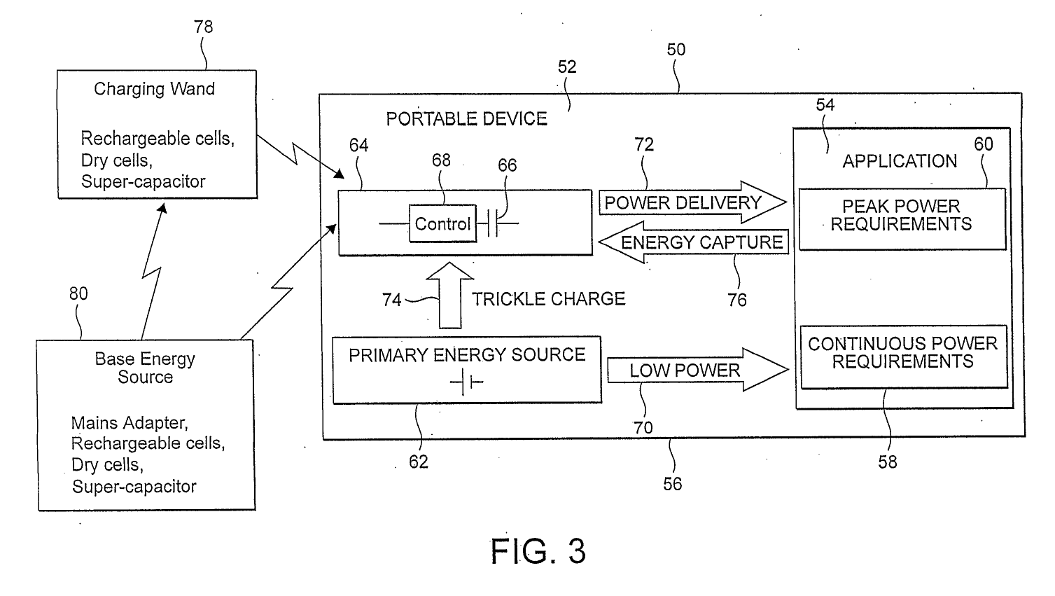

FIG. 3 is a schematic block diagram of a charging system for a portable electronic device in accordance with a third embodiment of the present invention;

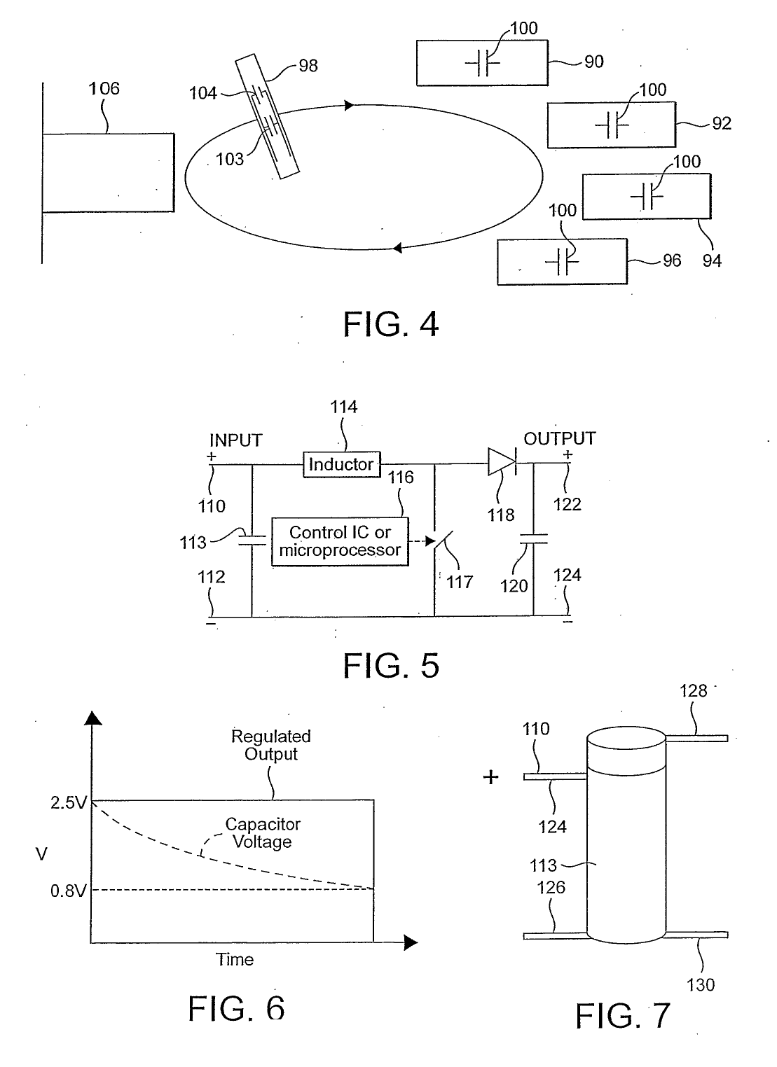

FIG. 4 is a schematic diagram of a charging system for a plurality of portable electronic devices in accordance with a fourth embodiment of the present invention;

FIG. 5 is a schematic diagram of a voltage regulator system in combination with a capacitor to provide a power supply for a portable electronic device in accordance with a fifth embodiment of the present invention;

FIG. 6 is a graph showing the relationship between output voltage and time for the power supply of FIG. 5;

FIG. 7 is a block diagram of the power supply of FIG. 5, illustrating how a voltage regulator may be packaged with the super capacitor;

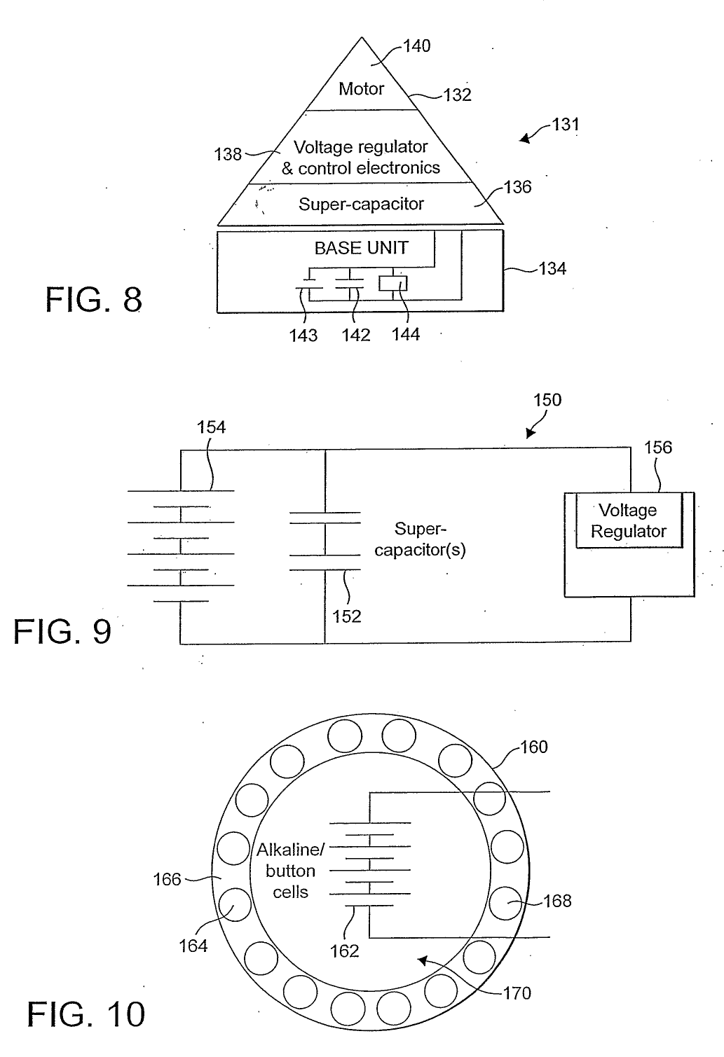

FIG. 8 is a schematic diagram of an electric razor and base unit having a power supply in accordance with a sixth embodiment of the present invention;

FIG. 9 is a schematic diagram of a power supply for a portable electronic device in accordance with a seventh embodiment of the present invention; and

FIG. 10 is a schematic diagram of a package containing consumables and at least one battery for a portable electronic device in accordance with an eighth embodiment of the present invention.

Referring to FIG. 1, in a first preferred embodiment of the present invention the rapid charge system, designated generally as 2, includes: a powered device 4 having a control circuit 6 to control the function of the device 4. The powered device 4 may be a delivery device and the control circuit 6 may act to control the duration of spray pulses and/or time between sprays so as to increase or reduce the rate of fluid dispense and the period between charges. A super-capacitor 8 is connected to the control circuit 6 to comprise a power source, using one or more super-capacitors capable of fast recharge, and to provide electrical power to the powered device 4, the control circuit 6 also functioning to regulate constant power from the super-capacitor 8 as it discharges. The device 4 has a user interface 10 and an element 12 delivering the function of the device, for example a spray mechanism. The device 4 may also be provided with a re-charge indicator (not illustrated); and/or an On/Off control (not illustrated), or alternatively the device may not have an On/Off switch or a recharge indicator.

In this embodiment the device 4 regulates delivery when the super-capacitor 8 has sufficient charge and stops spraying when there is insufficient charge to power the device, when the active has expired or when the control terminates spraying.

The device has a connector 14, acting as a charge point for the super-capacitor 8, to make electrical contact with a portable charging wand 16. Preferably, the recharge interface has a total impedance of not more than 0.3 Ohms. The portable charging wand 16 contains an electrical power source 18 comprising either batteries or another super-capacitor that can be carried around to rapidly recharge multiple portable devices around the home. When the electrical power source 18 comprises another super-capacitor it preferably has a higher capacitance than that of the super-capacitor 8 in the device 4 to be charged by the recharging wand 16. The recharging wand 16 contains circuitry 20 to rapidly charge one or more devices 4 suitable for household delivery. The device 4 and recharging wand 16 each have bodies to meet aesthetic and functional requirements of the product. The device 4 has a docking station, incorporating the connector 14, for the recharging wand 16, which can trickle charge or fast charge depending on the needs of the recharging wand 16. The electrical power source 18 of the wand 16 is in turn charged by selective docking with a base unit 21, which may be mains or battery powered, the latter using dry or rechargeable batteries, and/or may also have a super-capacitor for storing electrical charge for delivery to the wand 16. For the wand 16, preferably at least one of the input and output electrical connectors comprises low impedance contacts, having an impedance of not more than 0.2 Ohms, and the wand 16 has a total impedance of not more than 0.3 Ohms.

Once charged the power source will drive the delivery device for the required period of time, dependent on the average power required to deliver the active—a function of the quantity of active that is required to be delivered, its associated volatility and the delivery method being used. This could take the form of a pulsed fan system or more ideally low power piezoelectric spray nozzle technology. To extend the period of time between charges i.e. up to 10 days a control circuit having an on/off pulse mode could be included, the frequency and duration of the pulse being tailored to meet the specific needs of the product.

Referring to FIG. 2 in a second preferred embodiment of the present invention a delivery device 22 consists of: a reservoir 24 to contain the active to be emanated; a conduit 26 to transfer the active from the reservoir 26 to a delivery surface (not shown); a powered delivery means 30, preferably a piezoelectric spray nozzle (other embodiments may use a variety of other delivery mechanisms such as heaters, fans, mechanically activated aerosol spray; etc); a control circuit 32, to control the duration of spray pulses and/or time between sprays so as to increase or reduce the rate of fluid dispense and the period between charges (ideally the time between sprays is from 30 seconds to 30 minutes with a dispense volume of 0.01 mg-0.5 mg per pulse), and a power source 34, using one or more super-capacitors capable of fast recharge. The control circuit 32 acts to regulate constant power from the one or more super-capacitors 34 during discharge. A user interface 35 connects to the control circuit 32. A re-charge indicator and/or an On/Off control may be provided, or alternatively the device 22 may not have an On/Off switch or a recharge indicator, in which embodiment the device 22 starts when the super-capacitor 34 has sufficient charge and stops spraying when there is insufficient charge to power the device or the active has expired. A connector 36 is provided connected to the super-capacitor(s) 34, acting as a charge point selectively to make electrical contact with a portable charging wand 38, or a base charging unit 40 comprising a wireless recharge station, or a docking station at a mains electricity outlet. The portable charging wand 38 may contain either rechargeable batteries or another, preferably larger, super-capacitor that can be carried around to rapidly recharge multiple portable delivery devices around the home. In other embodiments, the portable charging wand could be replaced by a more permanent docking base charging unit 40, which could be mains or battery driven. The recharging wand 38 or base charging unit 40 contains circuitry to rapidly charge devices 22 suitable for household delivery. The device 22 has a body for the device to meet aesthetic and function requirements, and the recharge wand 38 and/or docking base charging unit 40 have a body to meet aesthetic and function requirements.

A further embodiment of the electrically powered portable charging device of the invention in combination with a further electrically powered portable device of the invention is shown in FIG. 3.

FIG. 3 shows a schematic drawing of a portable device chargeable by a portable charging device comprising a charging wand and/or a base source of energy comprising a base charging unit which portable device uses a super-capacitor. By way of example, the portable device may be a household delivery device; an electric razor; or a medical injector device. Such devices are not limited to those identified above, which are used purely as illustration, but could also take the form of a variety of hand held powered cleaning products, kitchen utensils, personal grooming, and medical healthcare products, etc., characterised by either: medium power portable devices used for a relatively short time, for illustration these could include electric razors, torches, whisks, hair clippers, diabetes control devices, etc., or lower powered portable devices that may be continuous, pulsed or used intermittently and for which having to wait an extended period of time for recharging provides significant inconvenience, for illustration this could be a household delivery device, etc.

The portable device, designated generally as 50, comprises a power module 52 integrated with an application module 54 in a common housing 56. The application module 54 comprises all the elements required to provide the device with the required functionality, for example motors, sensors, switches, displays, etc. Some elements have continuous power requirements, as represented by box 58, which require relatively low electrical power, for example to power a display or a clock whereas other elements have intermittent peak power requirements, as represented by box 60, which require relatively high electrical power for short periods, for example to drive a pulsed motor. In this embodiment, a primary energy source 62, typically comprising at least one battery, is provided, and this is arranged to provide the continuous low electrical power, represented by arrow 70, to the elements in box 58 which have continuous power requirements. A secondary energy source 64, comprising at least one storage capacitor 66, typically a super-capacitor, is also provided, and this is arranged to provide the peak high electrical power, represented by arrow 72, to the elements in box 60 which have intermittent peak power requirements. The secondary energy source 64 also incorporates a power control 68. The power control 68 regulates an incoming trickle charge, represented by arrow 74, from the primary energy source 62 to the at least one storage capacitor 66, and also regulates the outgoing power delivery, represented by the arrow 72, from the secondary energy source 64 to the application module 54. The power control 68 also regulates any incoming energy capture, represented by arrow 76, from the application module 54 to the at least one storage capacitor 66.

Optionally, the secondary energy source 64 may additionally be relatively rapidly charged (as compared to the trickle charge from the primary energy source 62) as shown in FIG. 3, by a portable charging wand 78 and/or by a base charging unit 80. As for the previous embodiments, the portable charging wand 78 can electrically mate with one or more portable powered household or medical devices having the electronics and circuitry developed so as to provide for very rapid re-charge in a consumer friendly way. The wand 78 may comprise at least one super-capacitor for storing charge to be delivered to the super-capacitor 66 in the device 52. The wand 78 may alternatively or additionally incorporate: replaceable primary cells, replaceable rechargeable cells, or non-replaceable re-chargeable batteries, which may themselves be adapted to be trickle charged through a docking base charging unit 80. The wand 78 would have control circuitry which provides the super-capacitor(s) 66 within the or each device 52 with high charging current flow and therefore provide for rapid charging of the super-capacitor(s) 66 by the wand 78 through a simple electrical mating operation. Such powered devices 52 are ideally suited to the use of fast charge super-capacitors 66 as the internal power source. Similarly, the docking base charging unit 80 may comprise one or more master super-capacitors with high power rating charged from a power source within the docking base charging unit 80, together with control circuitry to provide the super-capacitor(s) 66 within the device 52 with high current flow and therefore provide for rapid charging through a simple electrical mating operation.

When for example the device 52 is a household delivery device, the capacitance and therefore the physical size of the super-capacitor(s) 66 of the secondary energy source 62 would be dependant on the device needs and would ideally drive the device 52 for the expected discharge period for a discharge cycle for the active contained in the device 52, or until a consumer acceptable time period has elapsed between recharges of the device 52 has elapsed. This period would be dependent on the average power required to deliver the active, which is a function of the quantity of active that is required to be delivered, its associated volatility and the delivery method being used. The delivery mechanism of the application module 54 could take the form of a pulsed fan system, piezoelectric spray nozzle technology or aerosol spray technology. The period between charging could be increased by appropriate selection of the delivery cycle.

There follow example calculations, based on currently available air freshener devices. For an air freshener requiring average power of 6.8 mW per hour, for a super-capacitor having a capacitance of 80 Farads, this would provide three hours operating time per day for a total of three days, and the super-capacitor of the device would require recharging after three days. For an air freshener requiring average power of 4.6 mW per hour, for a super-capacitor having a capacitance of 60 Farads, this would provide three hours operating time per day for a total of three days, and the super-capacitor of the device would require recharging after three days. For an air freshener requiring average power of 4.6 mW per hour, for a super-capacitor having a capacitance of 60 Farads, this would provide one hour of operating time per day for a total of nine days, for example by providing a 30 second delivery period every 6 minutes for 12 hours per day, and the super-capacitor of the device would require recharging after nine days

In a particularly preferred embodiment of a household delivery device, multiple delivery devices 90, 92, 94, 96 (e.g. air fresheners) are sequentially charged from a wand 98, as shown in FIG. 4. As for the previous embodiments, the wand 98 comprises at least one super-capacitor 103 and/or one or more high current rated batteries 104. The super-capacitor 103 sources the peak power transfer to each of the delivery devices 90, 92, 94, 96 in turn. The wand 98 contacts with each delivery device 90, 92, 94, 96 in turn and rapidly transfers charge (ideally for a period of 2-15 seconds), direct from the batteries 104, or the larger capacitor 103, in the wand 98 to the smaller capacitor 100 in each delivery device 90, 92, 94, 96. When present, the wand capacitor 103 may be recharged from the wand battery 104 between charge transfers to each delivery device 90, 92, 94, 96. The wand capacitor 103/battery 104 recharges from a base charger unit 106 that may comprise larger batteries or preferably a mains plug-in charging unit.

In this embodiment, a typical delivery device requires 200 J based on 3 hours operation per day, for 3 days. In total therefore a total energy of 800 J needs to transfer from a wand 98 that charges four delivery devices 90, 92, 94, 96. Allowing 60 seconds between each charging of a delivery device 90, 92, 94, 96 for the wand capacitor 102 to recharge from the wand battery 104, requires 3.3 W power transfer, or about 0.9 A from three 1.2V AAA size rechargeable NiCd or NiMH batteries. Three AAA NiMH 750 mAh batteries have sufficient energy to charge about forty delivery devices before the wand batteries require recharge. The wand requires at least a 60 F capacitor, assuming the three 1.2V batteries charge the capacitor to 3.6V just prior to charge transfer. Each delivery device takes energy from the wand until the wand and device are at the same voltage, typically 2.5V. Control electronics within the wand ensures that the super-capacitor is not left charged to 3.6V for more than 60 seconds prior to discharge. Super-capacitors are damaged if left voltage stressed for extended time periods beyond the manufacturer's maximum voltage specification, typically 2.5V.

In a yet further embodiment of a household delivery device, as each device delivers active energy is taken from the capacitor and its voltage decays, control electronics within each delivery device is designed to boost the decaying voltage and regulate the voltage to the load. The regulated voltage depends on the load (e.g. fan, piezo spray nozzle, etc). Piezo spray technology may require significantly higher voltage (15V) than a fan motor (2.4V).

FIG. 5 shows a schematic representation of an example of a voltage regulator for use in the invention.

An input direct current (DC) voltage source is provided between terminals 110,112, the voltage source comprising a super-capacitor 113. An inductor 114 is in series with one terminal 110 and a control integrated circuit or microprocessor 116, controls a high-frequency (typically 100 kHz) switch 117, is in parallel with the DC voltage source, and serial arrangement of a diode 118 and a capacitor 120 is in parallel with the switch 117 controlled by the control integrated circuit or microprocessor 116, and the capacitor 120 has two output terminals 122, 124 thereacross. The general structure of such a voltage regulating circuit, absent the super-capacitor as the voltage source, is known per se.

The output voltage may be preset as a single value, or multiple output voltages may be provided.

In accordance with the invention, the input direct current (DC) voltage source provided between terminals 110,112 is from a super-capacitor 113 in the device which provides electrical power to the device, for example super-capacitor 100 in the previous embodiment. The voltage regulator acts to regulate the output voltage so as to provide constant output voltage even with varying input voltages. For example, the super-capacitor may have a nominal output voltage of 2.5 volts when fully charged. As the device is used, the stored electrical charge in the super-capacitor progressively diminishes, and the voltage of the super-capacitor progressively diminishes correspondingly. For example, the voltage may decrease with usage from 2.5 to 0.8 volts. This is shown in FIG. 6. If the super-capacitor output comprises the input for the voltage regulator, the input voltage varies between 0.8 to 2.5 volts from the super-capacitor. However, the regulated output voltage may be maintained at 2.5 volts. The power output would typically be about 10 mW. Therefore the voltage regulator acts to extend the useful life per charge for the super-capacitor power supply for use in the devices of the present invention, for example delivery devices, or personal grooming devices.

The super-capacitor and voltage regulator may be structured as shown in FIG. 7. The super-capacitor 113 and voltage regulator 122 are integrated to form a single packaged element, typically cylindrical or prismatic, having fast-charge input terminals 124, 126 connected across the super-capacitor 113 and regulated voltage output terminals 128, 130 connected across the combined circuit of the super-capacitor 113 and the voltage regulator 122. This provides the combination of a rapid charge with a regulated voltage output, thereby providing constant output power. This single packaged element of a voltage regulated capacitor power source may be made and sold separately for incorporation into powered devices. It may retain the external shape and dimensions commonly used for batteries thereby making it readily incorporated into powered devices.

In accordance with a further embodiment of the invention, as shown in FIG. 8 an electric razor system 131 comprises a razor 132 and a base unit 134. At least one super-capacitor 136 stores energy in the razor 132, and there are no batteries in the razor. The base unit 134 either comprises at least one super-capacitor 142 and battery 143 in combination and/or is mains powered (not shown), and has control electronics 144 to control the voltage output. The razor 132 interfaces with the base unit 134 via very low impedance contacts. The base unit 134 rapidly transfers energy to the razor 132 when electrical contact is made therebetween. Control electronics 138, including a voltage regulator, in the razor 132 boosts and regulates the voltage to the razor motor 140 to achieve constant power and sufficient blade speed to prevent hair snagging.

In one particular example, the razor super-capacitor 136 is specified to have a capacitance of at least 60 F based on requirements for 2 W motor power for the razor motor 140 and three minute usage prior to recharge. The razor super-capacitor 136 is initially charged to 3.6V from control electronics 144 in the base unit. The razor super-capacitor 136 delivers 360J to the load as its voltage decays from 3.6V to an assumed 0.8V cut-off. The base unit comprises four 1.2V NiCd or NiMH batteries, or has a plug-in mains adapter to isolate and convert AC mains voltage to 4.8V DC. The base unit 134 also comprises two super-capacitors specified at 140 F each and connected in series to provide 70 F at 4.8V. Energy is transferred from the base super-capacitor to the razor super-capacitor. In this example, 360 J are transferred within 10 seconds. Charging is complete when the voltages on the razor super-capacitor and base super-capacitor are equal.

In an alternative embodiment, and because the larger capacitors in the base unit are currently rather expensive, three rechargeable batteries in the base may directly charge the razor capacitor to 3.6V but more slowly e.g. within 30 seconds

In either embodiment control electronics within the razor ensures that the super-capacitor is not left charged to 3.6V for more than 60 seconds prior to discharge. This is because super-capacitors are damaged if the applied voltage is higher than the manufacturer's max voltage specification, typically 2.5V, for significant periods of time.

A yet further embodiment of a powered device in accordance with the invention comprises a medical device. There are a number of mechanical and battery powered medical devices on the market these include: delivery devices such as injectors, inhalers, etc; sampling and measuring devices, such as glucose monitors; and device compliance monitoring and communication devices. Medical injectors are either mechanical e.g. powered by a spring, or electrical e.g. powered by a direct solenoid actuator or a motor is provided to recharge a spring. Batteries add bulk (size and weight) to a device that is desirably discrete. There is a need for miniaturisation and portability (smaller/more efficient devices). Such injectors require high peak power for very short time, (e.g. 0.1-10 seconds).

In this embodiment, a medical device, such as an injector, comprises a power supply 150 as shown in FIG. 9. At least one super-capacitor 152 is used in combination with at least one battery 154 which is dimensionally small e.g. disposable coin cell or AAA size, and which may be a low cost alkaline battery. Plural batteries 154 are serially connected. The at least one super-capacitor 152, serially connected if more than one, is connected across the at least one battery 154 so as to be progressively trickle charged thereby. A voltage regulator 156, as described earlier, is connected across the at least one super-capacitor 152. The voltage regulator 156 provides a regulated voltage, as required, to the load of the injector.

This power supply arrangement, as compared to the use of batteries alone in known devices, significantly increases the battery cycle life of low cost batteries, e.g. alkaline batteries, at a comparable cost to upgrading to high power batteries. The use of a super-capacitor allow the batteries used to have smaller dimensions, the battery being dimensioned for energy storage rather than power requirements because the batteries do not need to be sized to meet peak power. This results in a more efficient use of energy. The use of super-capacitors makes the medical device smaller, lighter, and thus truly portable. The battery may be replaced with cartridge/refill to realise very compact product designs. A super-capacitor in combination with a low cost alkaline battery significantly increases the cycle life at a comparable cost to new high power batteries.

A similar power supply could be utilised for non-medical devices, for example short burst communication periodic delivery devices.

In a particular example, an injector for medical use which has an intermittent peak power requirement per use of 5 W for 0.25 seconds, assuming three uses per day, and four hours to recharge between uses, would require a 5 F capacitor. The injector would also have a small battery, e.g. two 1.2V NiMH cells, which would continuously trickle charge the capacitor. A 5 F super-capacitor measures approx 8 mm diameter×30 mm in length, which is significantly smaller than two AA or two AAA cells whilst more than matching the power output. Super-capacitors provide significant opportunity for making the medical device smaller, lighter, and thus truly portable. The space previously required for a battery may now be used to hold a cartridge/refill with/without an integral button cell battery enabling a very compact product design to be realised. The above figures for this example assume mid range auto injector power requirements. Higher power can be delivered by increasing the capacitor value. However, higher rated capacitors would take longer to fully charge without increasing battery cell size. Faster charging could be achieved through the introduction of higher voltage battery cells.

In a further example of a medical sampling and delivery device, this would have similar energy requirements to the auto injector described above, although power delivery would be over a slightly extended period, typically from 0.5-5 seconds. A typical device would have three uses per day, and 4 hours to recharge, which would require a 5 F capacitor. The capacitor would be trickle charged from small battery, e.g. two 1.2V NiMH cells.

In a further example of a medical device, which is a modification of the previous sampling and delivery device, as shown in FIG. 10 a replaceable package 160 comprises, in combination, a battery pack 162, comprising one or more disposable batteries, and a consumable pack 164. The battery pack 162 and the and a consumable pack 164 may be integrated into a common packaging element 166, for example a moulded plastic module, that can be inserted as a single unit into the medical device so as, in a single step, to insert fresh consumables 168 and a new battery pack 162 into the device. The consumables 168 may be disposed around, for example circumferentially around, a central portion 170 of the packaging element 166 in which the battery pack 162 is disposed. In this arrangement, the packaging element 166 may be configured such that it can be inserted directly into the device as a single recharge element, with the battery pack 162 being electrically connected to the device and the consumables being automatically located ready for sequential consumption by the device as part of the loading operation. Alternatively, the battery pack 162 and the consumable pack 164 may be integrated into a common packaging which is configured to be separable so that the consumables and the battery may be individually inserted into the device. For a sampling and delivery device the consumable pack 164 comprises a refill cassette including plural test strips or sampling points and the battery pack 162 comprises a battery having a capacity to meet energy requirements not peak power, for example a button cell. The use of a reduced size battery, as compared to known devices, provides reduced weight and size advantages over current designs. The use of an integrated battery together with the consumables ensures that there is always enough energy to completely service cassette requirements. As for the previous embodiments, a super-capacitor in the device ensures that peak power requirements and cycling frequency are met. The super-capacitor in the device ensures a more complete use of stored energy since the super-capacitor, rather than battery, delivers against energy need, providing for a more efficient use of power.

In a further embodiment of the invention, the replaceable electrical power source for an electrically powered portable device comprises, in combination, a battery pack, comprising one or more disposable batteries, at least one capacitor electrically connected to the battery pack, and output terminals for the power source electrically connected to the at least one capacitor. The battery pack may comprise a button cell. The power source may further comprise a voltage regulator for regulating the output voltage of the at least one capacitor. The voltage regulator may be adapted to output a voltage having a value substantially the same as the voltage of the at least one capacitor when fully charged. The power source may be cylindrical, prismatic or custom formed in shape.

1-42. (canceled)

43. An electrically powered portable device, the device being other than a toothbrush, the device including means for providing a function to be performed by the device, an electrical power supply which incorporates at least one capacitor for storing electrical charge to power the device, electronic control circuitry to control electrical power drawn from the electrical power supply for driving the function providing means, and a recharge interface for recharging the electrical power supply, the recharge interface being arranged to be electrically connectable to a charging device.

44. An electrically powered portable device according to claim 43 wherein the recharge interface is arranged to be selectively electrically connectable to a portable charging device or a charging base unit adapted to be powered by mains electrical power.

45. An electrically powered portable device according to claim 43 wherein the or each capacitor has a capacitance of from 5 to 50 Farad.

46. An electrically powered portable device according to claim 43 wherein the at least one capacitor has a working output voltage of from 1 V to 3.6V.

47. An electrically powered portable device according to claim 43 wherein the electrical power supply further comprises a voltage regulator for regulating the output voltage of the at least one capacitor.

48. An electrically powered portable device according to claim 47 wherein the voltage regulator is adapted to output a voltage having a value substantially the same as the voltage of the at least one capacitor when fully charged.

49. An electrically powered portable device according to claim 47 wherein the voltage regulator and the at least one capacitor are integrated to form a single packaged element which has a pair of input terminals and a pair of output terminals.

50. An electrically powered portable device according to claim 49 wherein the single packaged element is removable.

51. An electrically powered portable device according to claim 49 wherein the single packaged element is cylindrical, prismatic in shape or custom shaped

52. An electrically powered portable device according to claim 43 wherein the electrical power supply further incorporates a voltage source in combination with the at least one capacitor, the voltage source and the at least one capacitor being arranged so that the voltage source progressively charges the at least one capacitor for any period that the at least one capacitor is not fully charged.

53. An electrically powered portable device according to claim 52 wherein the voltage source comprises at least one battery.

54. An electrically powered portable device according to claim 53 wherein the at least one battery continuously provides low electrical power to the device and the at least one capacitor intermittently provides high electrical power to the device.

55. An electrically powered portable device according to claim 53 wherein the at least one battery continuously provides electrical power to at least one first component of the function providing means and the at least one capacitor intermittently provides high electrical power to at least one second component of the function providing means.

56. An electrically powered portable device according to claim 53 wherein the at least one battery is removable.

57. An electrically powered portable device according to claim 56 wherein the at least one battery is packaged together with at least one consumable of the device in a common package.

58. An electrically powered portable device according to claim 57 wherein the common package is removably mounted in the device.

59. An electrically powered portable device according to claim 43 wherein the recharge interface has a total impedance of not more than 0.3 Ohms.

60. An electrically powered portable charging device suitable for temporarily storing electrical charge for delivery to an electrical device electrically connectable to the charging device, the charging device comprising at least one storage element for temporarily storing electrical charge, an input for receiving, from a separate charging base unit to which the charging device is electrically connectable, an electrical charge to be stored by at least one storage element, and an output for delivering the stored electrical charge to the electrical device, the output comprising an electrical connector for selective electrical connection to an electrical device to be charged by the charging device.

61. A charging device according to claim 60 wherein the at least one storage element comprises at least one capacitor, the or each capacitor having a capacitance of 5 to 50 Farad.

62. A charging device according to claim 61 further comprising at least one battery electrically connected to the at least one capacitor so that the at least one battery progressively charges the at least one capacitor for any period that the at least one capacitor is not fully charged.

63. The combination of the electrically powered portable device of claim 43 and the charging device of claim 60.

64. An electrically powered portable device according to claim 43 which is a delivery device for release of at least one volatile compound stored in the device.

65. A delivery device according to claim 64, the delivery device comprising a reservoir for storing the at least one volatile compound, a dispensing device for dispensing the at least one volatile compound from a delivery surface of the dispensing device, the electronic control circuitry controlling the dispensing device, a conduit to transfer the at least one volatile compound from the reservoir to the delivery surface, and the at least one capacitor of the electrical power supply is capable of containing sufficient charge to power the dispensing device for a predetermined period.
